(19) United States
(12) Patent Application Publication
(10) Pub. No.: US 2025/0203026 A1
(43) Pub. Date: Jun. 19, 2025

(54) READING DEVICE, IMAGE PROCESSING APPARATUS, READING METHOD, AND NON-TRANSITORY RECORDING MEDIUM

(71) Applicants: Hirofumi ONO, Kanagawa (JP); Shogo NAKAMURA, Kanagawa (JP)

(72) Inventors: Hirofumi ONO, Kanagawa (JP); Shogo NAKAMURA, Kanagawa (JP)

(21) Appl. No.: 18/978,363

(22) Filed: Dec. 12, 2024

(30) Foreign Application Priority Data
Dec. 15, 2023 (JP) 2023-212551

(51) Int. Cl. H04N 1/00

(52) U.S. Cl. CPC H04N 1/0071; H04N 1/00745

(57) ABSTRACT

A reading device includes a light source to irradiate a subject with light, an imaging device to receive light reflected from the subject to generate an image, and circuitry to detect an edge of the subject to obtain a detection result, determine a size of the subject in accordance with the detection result, in a case that the detection result indicates that an upper edge or a lower edge of the subject in a main scanning direction of the imaging device is not detected at both ends, determine a width of the subject in the main scanning direction, and in a case that the detection result indicates that the upper edge or the lower edge of the subject in the main scanning direction is detected at both ends, determine the width of the subject in the main scanning direction to be a preset width.

### CROSS-REFERENCE TO RELATED APPLICATION

This patent application is based on and claims priority pursuant to 35 U.S.C. § 119 (a) to Japanese Patent Application No. 2023-212551, filed on Dec. 15, 2023, in the Japan Patent Office, the entire disclosure of which is hereby incorporated by reference herein.

### BACKGROUND

### Technical Field

The present disclosure relates to a reading device, an image processing apparatus, a reading method, and a non-transitory recording medium.

### Related Art

To prevent degradation in reading quality caused by the inclination and positional deviation of a document, the inclination of the document portion in image data read from the document is detected and corrected, and the document portion is cut out.

### SUMMARY

In one aspect, a reading device includes a light source to irradiate a subject with light, an imaging device to receive light reflected from the subject to generate an image, and circuitry to detect an edge of the subject to obtain a detection result, determine a size of the subject in accordance with the detection result, in a case that the detection result indicates that an upper edge or a lower edge of the subject in a main scanning direction of the imaging device is not detected at both ends, determine a width of the subject in the main scanning direction, and in a case that the detection result indicates that the upper edge or the lower edge of the subject in the main scanning direction is detected at both ends, determine the width of the subject in the main scanning direction to be a preset width.

In another aspect, a reading method performed by a reading device includes irradiating, with a light source, a subject with light, receiving, with an imaging device, light reflected from the subject to generate an image, detecting an edge of the subject to obtain a detection result, determining a size of the subject in accordance with the detection result. In a case that the detection result indicates that an upper edge or a lower edge of the subject in a main scanning direction of the imaging device is not detected at both ends, the method further includes determining a width of the subject in the main scanning direction, and in a case that the detection result indicates that the upper edge or the lower edge of the subject in the main scanning direction is detected at both ends, the method further includes determining the width of the subject in the main scanning direction to be a preset width.

In another aspect, a non-transitory recording medium storing a plurality of program codes which, when executed by one or more processors, causes the one or more processors to perform a method including irradiating, with a light source, a subject with light, receiving, with an imaging device, light reflected from the subject to generate an image, detecting an edge of the subject to obtain a detection result, determining a size of the subject in accordance with the detection result. In a case that the detection result indicates that an upper edge or a lower edge of the subject in a main scanning direction of the imaging device is not detected at both ends, the method further includes determining a width of the subject in the main scanning direction, and in a case that the detection result indicates that the upper edge or the lower edge of the subject in the main scanning direction is detected at both ends, the method further includes determining the width of the subject in the main scanning direction to be a preset width.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an image forming apparatus according to the first embodiment;

FIG. 2 is a diagram illustrating a configuration of an image reading device;

FIG. 3 is a diagram illustrating the disposition of a document width sensor;

FIG. 4 is a diagram illustrating a configuration of a reading section;

FIG. 5 is a block diagram illustrating electric connections of the components of an image reading device;

FIG. 6 is a block diagram illustrating a functional configuration of an image processor;

FIG. 7 is a graph illustrating the difference in spectral reflection characteristics depending on a medium;

FIG. 8 is a diagram illustrating the difference between a visible image and an invisible image;

FIG. 9 is a diagram illustrating edge detection of a subject;

FIG. 10 is a diagram illustrating correction of the inclination and position of a document;

FIG. 11 is a diagram illustrating information obtained from an edge of a subject;

FIGS. 12A and 12B are diagrams each illustrating an edge detection method;

FIGS. 13A and 13B are diagrams each illustrating a feature amount utilizing an edge;

FIG. 14 is a diagram illustrating selection of a line equation in a regression line equation;

FIGS. 15A and 15B are diagrams each illustrating the reading of a document of an irregular size;

FIGS. 16A and 16B are diagrams each illustrating the execution of edge detection of the upper side of a document in image data;

FIG. 17 is a diagram illustrating the case where an upper edge in the main scanning direction is not detected at both ends;

FIG. 18 is a flowchart of the process of size determination;

FIG. 19 is a diagram illustrating the disposition of a document width sensor in an image reading device according to the second embodiment;

FIGS. 20A and 20B are diagrams each illustrating edge detection in an image reading device according to the second embodiment;

FIGS. 21A and 21B are diagrams each illustrating edge detection in an image reading device according to the third embodiment;

FIGS. 22A to 22C are diagrams each illustrating a reading device according to a modification; and

FIG. 23 is a diagram illustrating a reading device according to another modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A reading device, an image processing apparatus, a reading method, and a non-transitory recording medium according to embodiments of the present disclosure are described in detail below with reference to the accompanying drawings.

### First Embodiment

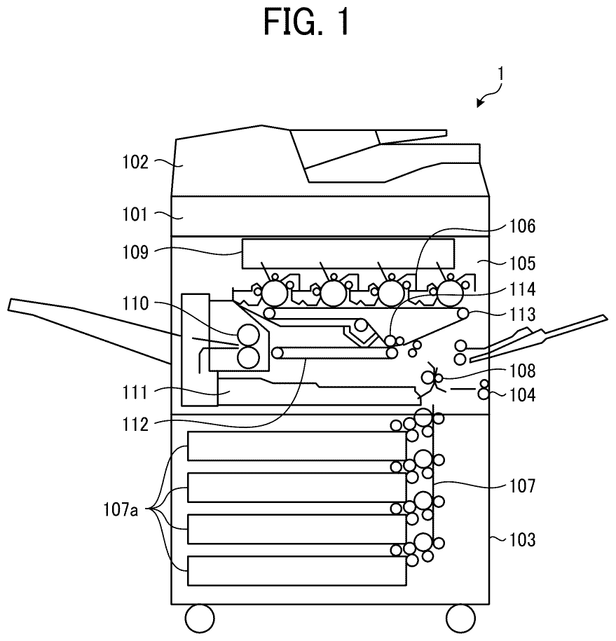

FIG. 1 is a diagram illustrating a configuration of an image forming apparatus 1 according to the first embodiment. In FIG. 1, the image forming apparatus 1, which is an image processing apparatus, is an apparatus typically referred to as a multifunction peripheral having at least two of a copying function, a printing function, a scanning function, and a facsimile communication function.

The image forming apparatus 1 includes an image reading device 101 serving as a reading device, and an image forming device 103 below the image reading device 101. In order to describe the internal configuration of the image forming device 103, FIG. 1 illustrates the internal configuration of the image forming device 103 from which the external cover is removed.

The image reading device 101 includes an automatic document feeder (ADF) 102 attached to the upper portion of a main body 10 of the image reading device 101. The ADF 102 is a document supporter that positions, at a reading position, a document from which an image is read. The ADF 102 automatically feeds the document placed on a placement table to the reading position. The image reading device 101 reads the document conveyed by the ADF 102 at a predetermined reading position. The image reading device 101 has, on a top side thereof, an exposure glass that is a document support on which a document is placed, and reads the document on the exposure glass that is the reading position. Specifically, the image reading device 101 includes a light source, an optical system, and a solid-state image sensing device such as a complementary metal oxide semiconductor (CMOS) image sensor inside. The image reading device 101 reads, with the solid-state image sensing device through the optical system, reflected light reflected from the document irradiated with light from the light source.

The image forming device 103 includes a bypass feeding roller pair 104 through which a recording sheet is manually inserted and a recording sheet feeder 107 that supplies the recording sheet. The recording sheet feeder 107 includes an assembly that sends out recording sheets one by one from vertically-aligned sheet trays 107a. The recording sheet thus supplied is sent to a secondary transfer belt 112 via a registration roller pair 108.

Onto the recording sheet conveyed on the secondary transfer belt 112, a transfer device 114 transfers a toner image from an intermediate transfer belt 113.

The image forming device 103 also includes an optical writing device 109, image forming units (for yellow (Y), magenta (M), cyan (C), and black (K)) 105 employing a tandem system, the intermediate transfer belt 113, and the secondary transfer belt 112. The image forming device 103 forms, through an image forming process performed by the image forming units 105, the image written by the optical writing device 109 as a toner image on the intermediate transfer belt 113.

Specifically, the image forming units (for Y, M, C, and K) 105 include four photoconductor drums (for Y, M, C, and K) in a rotatable manner, and image forming elements 106 around the respective photoconductor drums. The image forming elements 106 include a charging roller, a developing device, a primary transfer roller, a cleaner unit, and a discharger. The image forming element 106 functions on each photoconductor drum, and the image on the photoconductor drum is transferred onto the intermediate transfer belt 113 by each primary transfer roller.

The intermediate transfer belt 113 is entrained around a drive roller and a driven roller, and disposed so as to pass through primary transfer nips between the four photoconductors and the respective primary transfer rollers. As the intermediate transfer belt 113 rotates, the toner images primarily transferred onto the intermediate transfer belt 113 are conveyed to a secondary transfer device, which secondarily transfers the toner images as a composite toner image onto a recording sheet on the secondary transfer belt 112. As the secondary transfer belt 112 rotates, the recording sheet is conveyed to a fixing device 110. The fixing device 110 fixes the composite toner image as a color image onto the recording sheet. Then, the recording sheet is ejected onto an output tray outside the image forming apparatus 1. In the case of duplex printing, a reverse assembly 111 reverses the front and back sides of the recording sheet and sends out the reversed recording sheet onto the secondary transfer belt 112.

The image forming device 103 is not limited to the one that forms an image using an electrophotographic method as described above. The image forming device 103 may be one that forms an image using an inkjet method.

The image reading device 101 is described below.

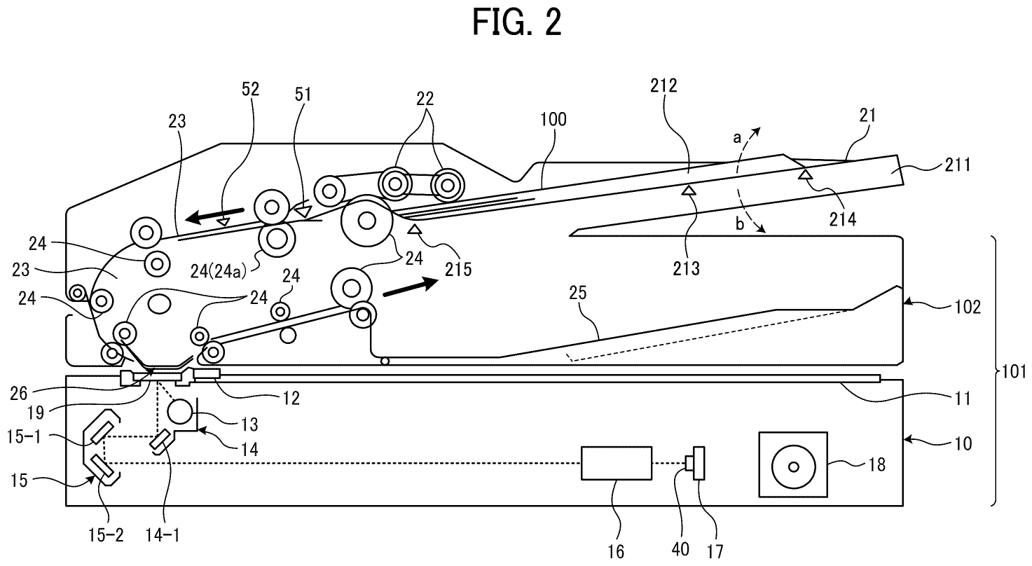

FIG. 2 is a diagram illustrating a configuration of the image reading device 101. The main body 10 of the image reading device 101 includes an exposure glass 11 on the upper face. The image reading device 101 includes, for example, a light source 13, a first carriage 14, a second carriage 15, a lens unit 16, and a sensor board 17 inside the main body 10. In FIG. 2, the first carriage 14 includes the light source 13 and a reflection mirror 14-1 whereas the second carriage 15 includes reflection mirrors 15-1 and 15-2.

The light source 13 emits light to a subject to be read. The reflected light from the subject is reflected by the reflection mirror 14-1 of the first carriage 14 and the reflection mirrors 15-1 and 15-2 of the second carriage 15. Then, the reflected light is incident on the lens unit 16, which forms an image of the subject on the light-receiving face of the sensor board 17. The sensor board 17 includes an imaging device 40 which is a line sensor such as a charge-coupled device (CCD) or a CMOS. The sensor board 17 sequentially converts the image of the subject to be read, which is formed on the light-receiving face of the imaging device 40, into an electrical signal. A reference white plate 12 is a white density reference member that is read for correcting, for example, a change in the light amount of the light source 13 or variations in pixels (pixel circuits) of the imaging device 40.

The image reading device 101 includes a control board in the main body 10, which controls the components in the main body 10 and the components in the ADF 102 to read a subject to be read in a predetermined reading method. The subject to be read is, for example, a recording medium on which characters or patterns are formed. In the following description, this recording medium is referred to as a document. The document corresponds to a “subject” and is given by way of example as a sheet or a transparent sheet such as an overhead projector (OHP) transparency. However, the document is not limited thereto.

The image reading device 101 reads a document 100 in a sheet-through method using the ADF 102. The ADF 102 is an example of a “feeder.” In the configuration of the image reading device 101 illustrated in FIG. 2, the image reading device 101 separates, with pickup rollers 22, documents 100 one by one from a stack of documents 100 on a tray 21 of the ADF 102, conveys the document 100 to a conveyance path 23, reads the side to be read of the document 100 at a predetermined reading position in the reading section, and ejects the document 100 onto an output tray 25. The document 100 is conveyed by the rotation of a variety of conveyance rollers 24.

Among the variety of conveyance rollers 24, a pair of rollers that performs primary striking alignment (so-called skew correction) on the fed document 100 and pulls out and conveys the aligned document 100 is referred to as pull-out rollers 24a. A contact sensor 51 is disposed in the vicinity of the pull-out rollers 24a.

The tray 21 includes a movable document table 211 that rotates in the directions of arrows a and b in FIG. 2 with a base end of the tray 21 as a fulcrum, and a pair of side fences 212 that positions the document 100 in the left-right direction relative to the sheet feeding direction. By the movable document table 211 rotating, the front end of the document 100 in the sheet feeding direction is adjusted to an appropriate height.

On the tray 21, document-length detection sensors 213 and 214 for detecting whether the document 100 is in portrait orientation or landscape orientation are disposed at a distance from each other in the sheet feeding direction. As the document-length detection sensors 213 and 214, reflection sensors that detect the document length by an optical means without contacting the document or actuator sensors that detect the document length by contacting the document may be used.

The pair of side fences 212 is slidable in the left-right direction with respect to the sheet feeding direction, and is configured to allow the documents 100 of different sizes to be placed thereon. A document set sensor 215 for detecting that the document 100 is placed on the tray 21 is provided for the pair of side fences 212.

A document width sensor 52 that serves as a detection sensor is disposed in the conveyance path 23 downstream of the pull-out rollers 24a in the document conveyance direction.

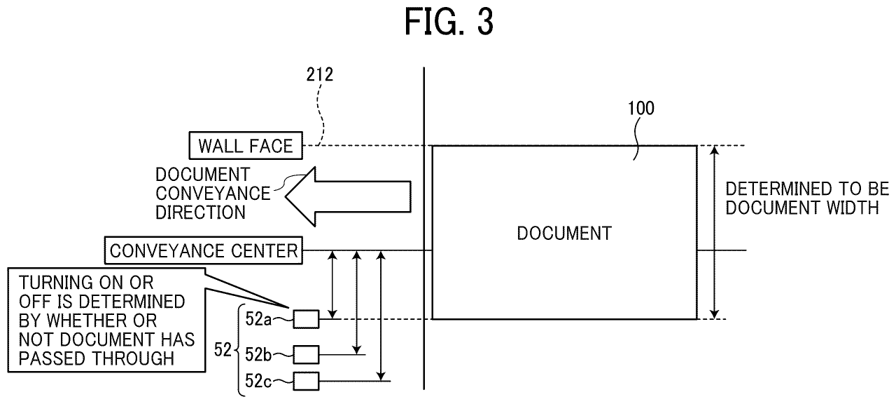

FIG. 3 is a diagram illustrating the disposition of the document width sensor 52. As illustrated in FIG. 3, the document width sensor 52 includes, for example, multiple light-receiving elements (52a, 52b, 52c) that serve as sensors disposed in the width direction of the document 100 from a side fence 212 serving as an example of a document placement reference in accordance with the size of the standard document of each document 100. The document width sensor 52 detects the document width of the document 100 based on the result of light received from the irradiation light disposed at the opposing position across the conveyance path 23. The length of the document 100 in the conveyance direction is detected from the motor pulse generated when the leading and trailing edges of the document 100 are read by the contact sensor 51 disposed in the vicinity of the pull-out rollers 24a.

For example, the image reading device 101 causes the document 100 to pass between a reading window 19 and a background portion 26 with the first carriage 14 and the second carriage 15 moved to and fixed at predetermined home positions. The reading window 19 is a slit-shaped window formed as a part of the exposure glass 11. The background portion 26 is a member facing the reading window 19. While the document 100 passes through the reading window 19, the reading section irradiates a first side (front side or back side) of the document 100 facing the reading window 19 with light from the light source 13 and receives the reflected light with the imaging device 40 on the sensor board 17 to read an image. The background portion 26 may be of any size that the imaging range of the imaging device 40 can cover, and may be, for example, a metal plate or a roller.

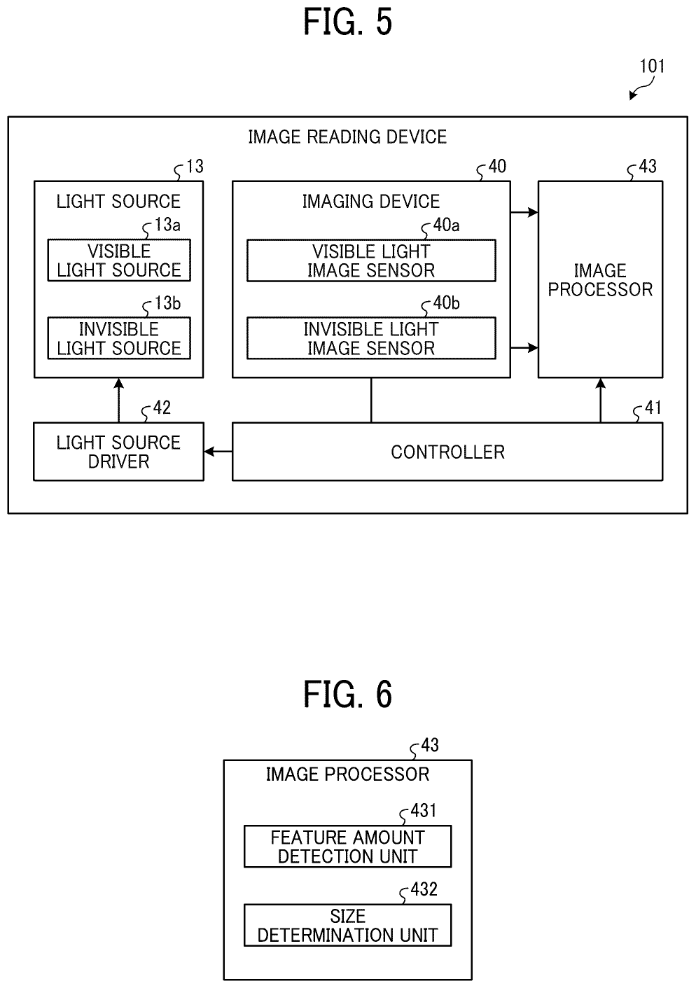

The reading section as a first reading section includes, for example, the light source 13, the background portion 26, an optical system that guides the reflected light from the document 100 to the imaging device 40 on the sensor board 17, and the imaging device 40. The optical system includes, for example, the reflection mirror 14-1, the reflection mirrors 15-1 and 15-2, and the lens unit 16. A detailed description of the configuration of the reading section will be described later with reference to FIG. 5.

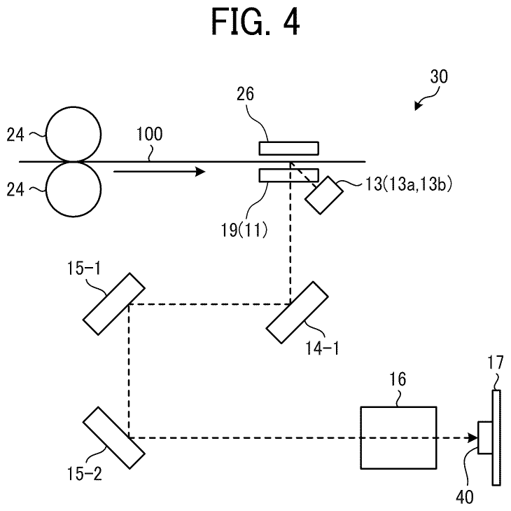

In the case of performing double-sided scanning on the document 100, for example, a reversing assembly is arranged to reverse the front and back sides. The image reading device 101 reverses the document 100 with the reversing assembly and reads a second side of the document 100 at the reading position (reading window 19) of the reading section. Instead of the reversing assembly, another configuration such as a second reading section may be arranged to read the second side of the document 100. For example, after the document 100 passes through the reading window 19, the second side of the document 100 is read by a reading section (the second reading section) including a reading sensor that is disposed to read the back side of the document 100. In this case, a member facing the reading sensor corresponds to the background portion 26 (see FIG. 4).

The configuration of the image reading device 101 according to the present embodiment allows reading in a flatbed method. Specifically, the ADF 102 is lifted to expose the exposure glass 11 and the document 100 is directly placed on the exposure glass 11. Then, the ADF 102 is lowered to the original position to press the back side of the document 100 with the lower portion of the ADF 102. In the flatbed method, since the document 100 is fixed, the first carriage 14 and the second carriage 15 are moved relative to the document 100 to scan the document 100. The first carriage 14 and the second carriage 15 are driven by a scanner motor 18 to scan the document 100 in the sub-scanning direction. For example, the first carriage 14 moves at a speed V, and at the same time, the second carriage 15 moves at a speed ½ V, which is half the speed of the first carriage 14, in conjunction with the movement of the first carriage 14. Thus, the first side of the document 100 facing the exposure glass 11 is read. In this case, the lower portion of the ADF 102 is a member that presses the back side of the document 100 and corresponds to the background portion 26 (see FIG. 4).

In the present embodiment, for example, the first carriage 14, the second carriage 15, the lens unit 16, and the sensor board 17 are separately illustrated, but these components may be individually provided or may be provided as an integrated sensor module.

FIG. 4 is a diagram illustrating a configuration of a reading section 30. In FIG. 4, the configuration and conveyance mechanism of the reading section 30 (the first reading section) that reads the first side of the document 100 are given by way of example. As illustrated in FIG. 4, the document 100 sent by the variety of conveyance rollers 24 passes between the reading position (reading window 19) of the exposure glass 11 and the background portion 26.

The reading section 30 includes the background portion 26 as a set. While the document 100 passes the reading window 19, the reading section 30 irradiates the first side of the document 100 facing the reading window 19 with light from the light source 13 and receives the reflected light from the first side of the document 100 through the path illustrated in the broken line in FIG. 4 with the imaging device 40 on the sensor board 17 to read an image.

The configuration of the reading section is not limited to the configuration of the first reading section. The configuration may be modified as appropriate in accordance with a method of reading with a contact image sensor employed in the second reading section or another configuration of the image reading device.

As illustrated in FIG. 4, the light source 13 according to the present embodiment includes a visible light source 13a and an invisible light source 13b. The light source 13 is an illuminator that irradiates a subject with visible light and invisible light. The visible light source 13a irradiates the subject and the background portion 26 with visible light. The invisible light source 13b irradiates the subject and the background portion 26 with invisible light. Use of an infrared light source as the invisible light source 13b is effective. In general, the visible light wavelength range is from 380 nm to 750 nm, and the range from 750 nm onward is the infrared wavelength range, which is the range of invisible light.

In the present embodiment, the invisible light source 13b emits invisible light in the infrared wavelength range of 750 nm or more. However, the invisible light is not limited thereto. The invisible light source 13b may emit invisible light in the ultraviolet wavelength range of 380 nm or less.

FIG. 5 is a block diagram illustrating electric connections of the components of the image reading device 101. As illustrated in FIG. 5, the image reading device 101 includes a controller 41, a light source driver 42, and an image processor 43 in addition to the imaging device 40 and the light source 13. The controller 41 controls the imaging device 40, the light source driver 42, and the image processor 43. The light source driver 42 drives the light source 13 under the control of the controller 41. The imaging device 40 transfers signals to the image processor 43 that is disposed in the subsequent stage.

The imaging device 40 includes an invisible light image sensor 40b that functions as an invisible image reading unit and a visible light image sensor 40a that functions as a visible image reading unit. The imaging device 40 receives the visible light and the invisible light reflected from the subject and captures a visible image and an invisible image. More specifically, the invisible light image sensor 40b reads the invisible reflected light reflected from the subject, which is a part of the invisible light, to acquire an invisible image (an image in the invisible light wavelength range). The visible light image sensor 40a reads the visible reflected light reflected from the subject, which is a part of the visible light, to acquire a visible image (an image in the visible light wavelength range). The invisible light image sensor 40b and the visible light image sensor 40a are sensors for a reduction optical system, such as a CMOS image sensor.

The visible light image sensor 40a and the invisible light image sensor 40b may be integrally configured. Such a configuration can make the sensor structure compact and the reading positions of the visible light and the infrared light closer to each other. Accordingly, lost information can be extracted and restored with high accuracy. In other words, such a configuration can eliminate deviations of the image, which may occur when the image is read a plurality of times, and correction can be made with high positional accuracy.

The image processor 43 executes various kinds of image processing on image data according to a purpose of use. The image processor 43 may be implemented by a hardware circuit or may be implemented by a central processing unit (CPU) executing a program.

FIG. 6 is a block diagram illustrating a functional configuration of the image processor 43. As illustrated in FIG. 6, the image processor 43 includes a feature amount detection unit 431 and a size determination unit 432. The image processor 43 detects, with the feature amount detection unit 431, the feature amount of one of the subject and the background portion 26 from at least one of the visible image and the invisible image obtained from the main body 10 of the image reading device 101. The feature amount is, for example, an edge between the background portion 26 and the document 100. The image processor 43 uses the detected feature amount for the correction process of the image itself, which will be described in detail later.

The feature amount detection unit 431 functions as an edge detection unit that detects an edge of the subject. More specifically, the feature amount detection unit 431 detects an edge by, for example, detecting the difference in density between the document 100 and the background portion 26, or by detecting a shadow between the document 100 and the background portion 26. In the present embodiment, detecting an edge means detecting the boundary between the document 100 and the background.

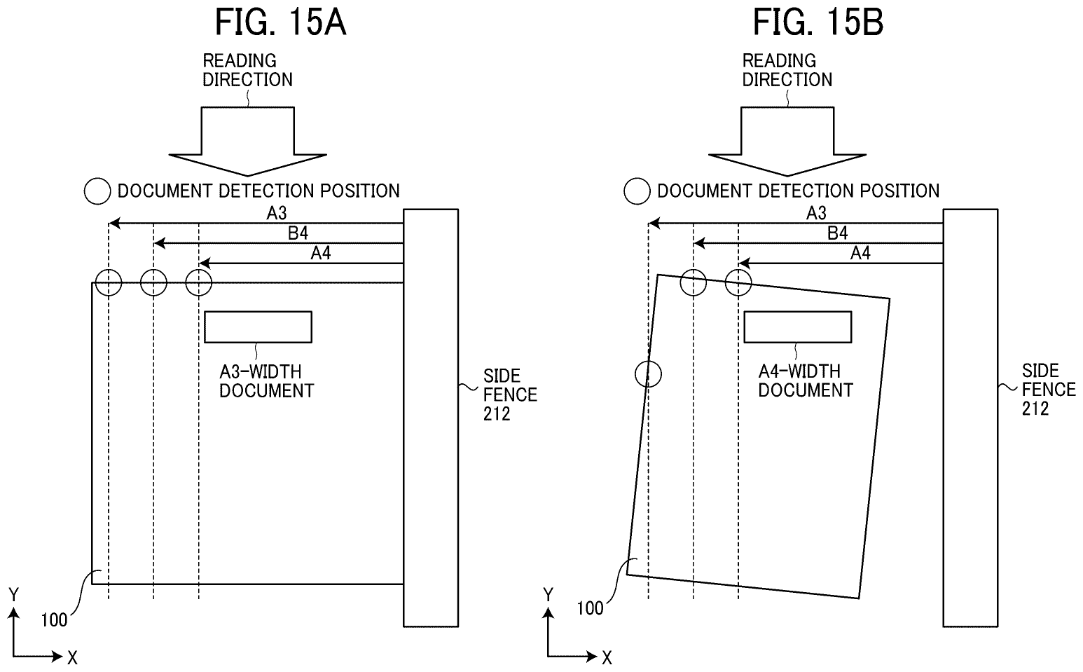

The size determination unit 432 receives the detection result from the feature amount detection unit 431 and determines the size of the document based on the detection result. More specifically, in the case where the upper edge of the document 100 in a main scanning direction X (see FIG. 15A, etc.) is not detected at both ends by the feature amount detection unit 431 (the document 100 is smaller than the detectable range), the size determination unit 432 determines the width of the document 100 in the main scanning direction X (referred to as the main scanning width in the following description). In addition, in the case where the upper edge of the document 100 in the main scanning direction X is detected at both ends by the feature amount detection unit 431 (the document 100 is larger than the detectable range), the size determination unit 432 determines the main scanning width of the document 100 to be a predetermined width (e.g., A3 width).

The difference in spectral reflection characteristics depending on the medium in the imaging device 40 is described below.

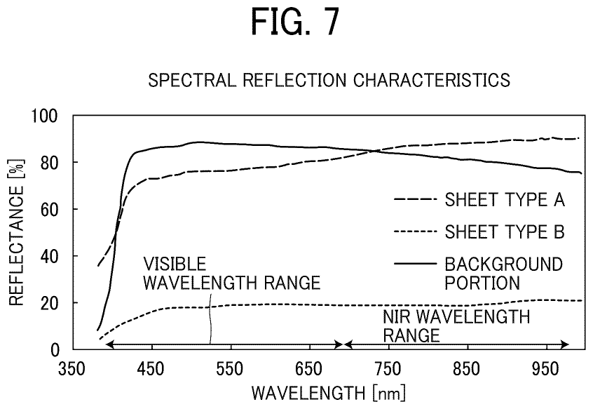

FIG. 7 is a graph illustrating the difference in spectral reflection characteristics depending on a medium. In FIG. 7, a graph is illustrated, which indicates the spectral reflection characteristics of two types of plain paper sheets such as a sheet type A and a sheet type B, and the background portion 26. The sheet type A and the sheet type B are typically used as documents, which are subjected to reading by the image reading device 101. In FIG. 7, the alternate long and short dash line indicates the spectral reflection characteristic of the plain paper sheet of the sheet type A. The dotted line indicates the spectral reflection characteristic of the plain paper sheet of the sheet type B. The solid line indicates the spectral reflection characteristic of the background portion 26.

As illustrated in FIG. 7, the reflectance of the background portion 26, which is a white background, is higher than that of the plain paper sheet (sheet type A) in the visible wavelength range whereas the reflectance of the background portion 26 is lower than that of the plain paper sheet (sheet type A) in the near-infrared (NIR) wavelength range.

In addition, as illustrated in FIG. 7, the reflectance of the background portion 26 is higher than that of the plain paper sheet (sheet type B) in both the visible wavelength range and the NIR wavelength range.

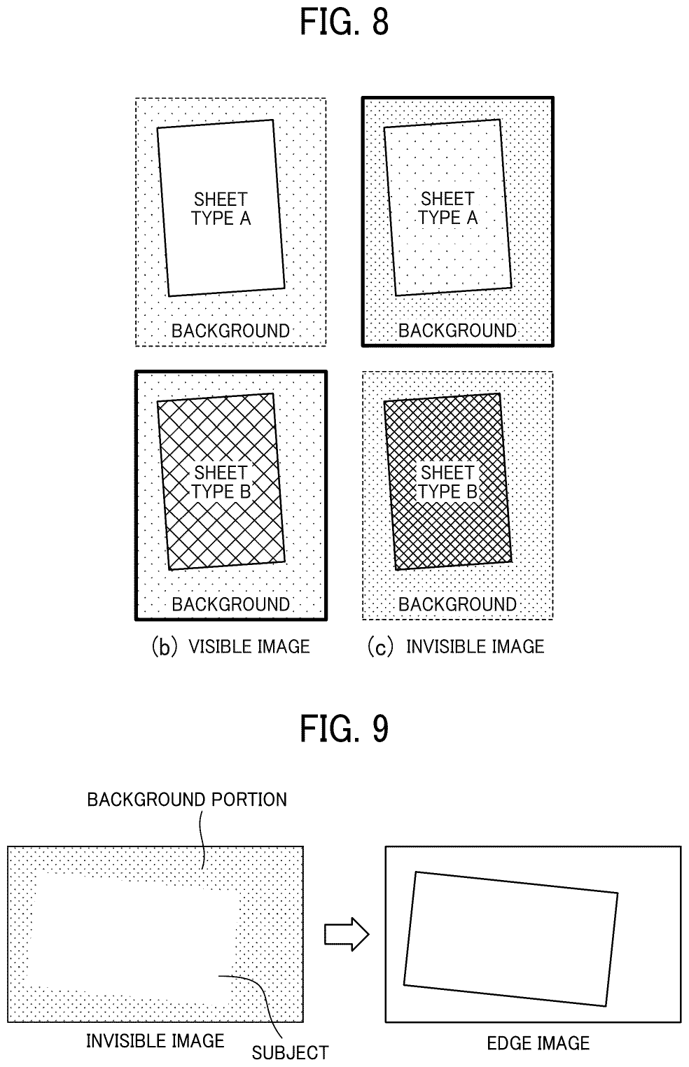

FIG. 8 is a diagram illustrating the difference between the visible image and the invisible image. As illustrated in FIG. 8, when the reflected light is read by the imaging device 40, the spectral reflection characteristics of the background portion 26 and the document are different, and images having different feature amounts are obtained with the visible light and the invisible light. For this reason, the target feature amount can be easily obtained when the image subjected to detecting is set in advance as one of the visible image and the invisible image, based on the type of the subject or the type of the background portion 26.

For example, in the case of the example illustrated in FIG. 8, since the invisible image of the sheet type A has a difference in spectral reflection characteristic from the background portion 26 larger than the visible image of the sheet type A, the image subjected to detecting for the feature amount may be set to be the invisible image. By contrast, for the sheet type B, the image subjected to detecting for the feature amount may be set to be the visible image.

Note that the feature amount may be extracted from both the visible image and the invisible image, and is selected or integrated from the extracted feature amounts.

An example of edge detection and an example of correction of the inclination and position performed by the feature amount detection unit 431 for the document 100 that is the subject are described below.

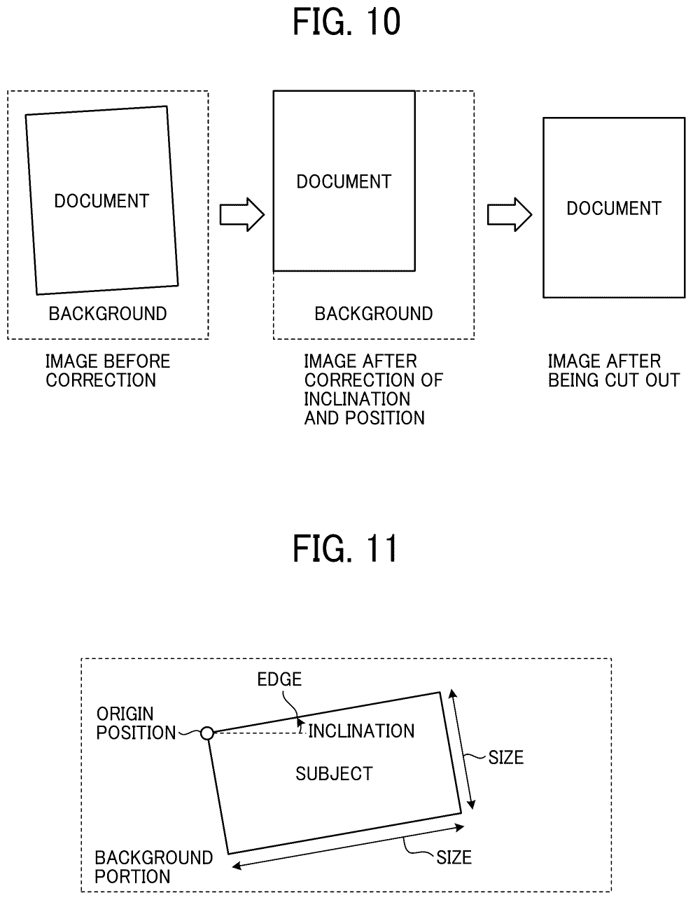

FIG. 9 is a diagram illustrating edge detection of the subject. FIG. 10 is a diagram illustrating correction of the inclination and position of the document. FIG. 11 is a diagram illustrating information obtained from the edge of the subject. For example, as illustrated in FIG. 9, when an edge between the background portion 26 and the document 100 is extracted from an image, it is preferable to reduce the reflectance of the background portion 26 and use an invisible image. Also, as illustrated in FIG. 10, when the inclination and position of the document are corrected and an image of the document is cut out, it is preferable to reduce the reflectance of the background portion 26 and use an invisible image. When reading the document with invisible light in this manner, an image is obtained, in which the document 100 is bright and the background portion 26 is dark. This is because the reflectance of the invisible light of the background portion 26 is low. Since the difference between the document 100 and the background portion 26 is clearly visible, the edge can be easily detected. In other words, the difference in density between the document 100 and the background portion 26 is increased, and the edge detection can be performed with higher accuracy.

As illustrated in FIG. 11, the edge refers to a boundary between the document 100, which is the subject, and the background portion 26. By detecting such an edge, as illustrated in FIG. 11, for example, the position, inclination, and size of the document 100 that is the subject can be recognized. Based on the position, inclination, and size of the document 100 that is the subject, image correction can be performed in accordance with the position, inclination, and size of the document 100 that is the subject in the process of the subsequent stage.

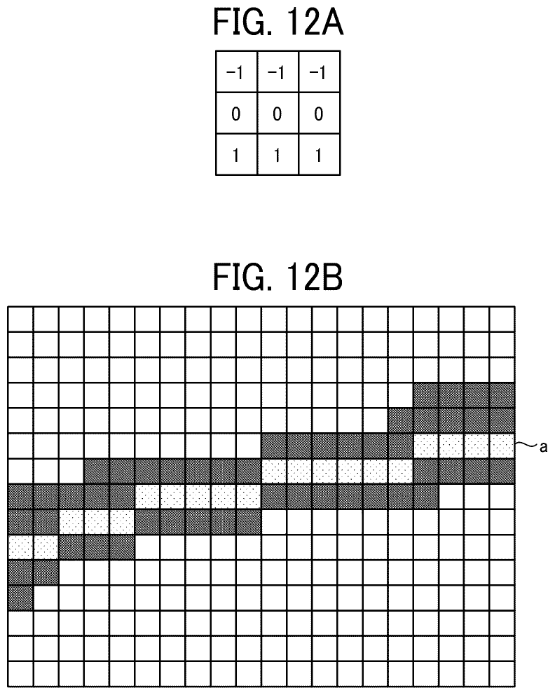

FIGS. 12A and 12B are diagrams each illustrating an edge detection method. As an edge detection method, for example, as illustrated in FIG. 12A, a method of applying a first-order differential filter to the entire image and binarizing each pixel depending on the determination of whether the pixel has a value exceeding a predetermined threshold value is considered. In such a method, depending on the threshold value, an edge in a horizontal direction appears consecutively by several pixels in the vertical direction, and vice versa. This is because the edge is blurred primarily due to the modulation transfer function (MTF) characteristics of the optical system. In view of the above, as illustrated in FIG. 12B, for example, the center of the consecutive pixels is selected as indicated by “a” in FIG. 12B to obtain a representative edge pixel for, for example, the calculation of a regression line equation and the detection of size. The calculation of a regression line and the detection of size will be described later in detail.

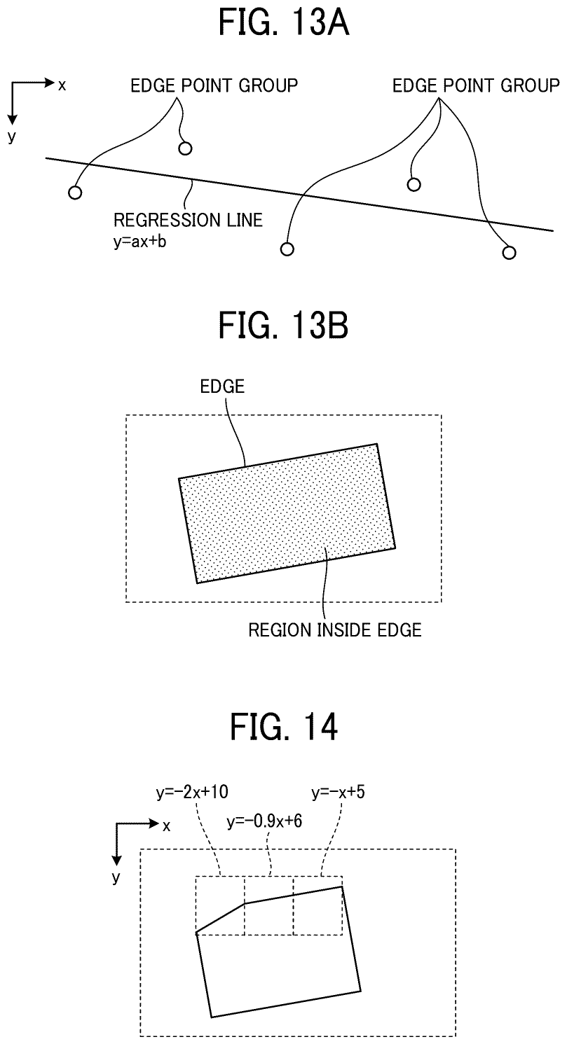

FIGS. 13A and 13B are diagrams each illustrating a feature amount utilizing an edge. The feature amount may not be the edge itself extracted from the image, but may be something that utilizes the edge. As an example, as illustrated in FIGS. 13A and 13B, respectively, a regression line equation calculated from the extracted edge point group by using, for example, the least square method, or a region (a collection of positions) inside the edge are considered. As for the regression line equation, there is a method of obtaining a single line equation based on the information on the entire edge for each side. In addition, there is another method of dividing the edge into multiple regions to calculate line equations and selecting a representative line equation from the line equations or integrating representative line equations. In this case, as a method of deriving the final line equation, a method of obtaining a straight line whose inclination is a median value or the average value of the multiple line equations is considered.

FIG. 14 is a diagram illustrating selection of a line equation in the regression line equation. By dividing the edge into multiple regions to calculate line equations and selecting a representative line equation from the line equations or integrating representative line equations, as illustrated in FIG. 14, the inclination of the document 100 that is the subject can be correctly recognized even when the document 100 that is the subject is damaged, for example, missing a part of the edge.

As described above, by the feature amount detection unit 431 extracting, as a feature amount, an edge of the document 100 that is the subject, the region of the document 100 that is the subject can be detected.

As described above, the image reading device 101 of the present embodiment can detect the width of the document 100 using the document width sensor 52.

As illustrated in FIG. 3, the document width sensor 52 includes, for example, the light-receiving elements (52a, 52b, 52c) disposed at predetermined intervals in the width direction of the document 100. The light-receiving elements (52a, 52b, 52c) of the document width sensor 52 are disposed at positions that allow the document width sensor 52 to determine which regular size the document 100 is. Thus, when the document 100 of a regular size is passed, the size of the document 100 is determined based on the information on the position of a light-receiving element of the document width sensor 52 that has reacted.

An issue in the method of detecting the document size of the document 100 in the art is described below.

FIGS. 15A and 15B are diagrams each illustrating the reading of the document 100 of an irregular size. In the following drawings, the main scanning direction of the imaging device 40 is denoted by X, and the document conveyance direction is denoted by Y. As described above, according to the technique in the art, when the document 100 of an irregular size is read, the size to be read is not designated by, for example, a user operation. The size is automatically determined when the document 100 is read. For this reason, when the size is determined at one end where the document width sensor 52 is disposed, an erroneous determination may occur depending on the state of the document 100.

For example, as illustrated in FIG. 15A, when the document 100 of A3 width is placed at the position of document placement reference, such as the side fence 212, for detecting the size of the document 100, the document 100 of A3 width can be detected to be A3 in width.

However, as illustrated in FIG. 15B, when the document 100 of A4 width is not placed at the position of document placement reference for detecting the size of the document 100 or when the document 100 of A4 width is inclined, the document 100 of A4 width is erroneously detected to be A3 in width even though the document 100 of A4 width is actually A4 in width.

In view of the above, in order to prevent the erroneous detection described above, the size determination unit 432 of the image processor 43 according to the present embodiment adopts a configuration in which the size of the document 100 is determined by detecting both ends of the left and right sides of the document 100 in the image data, rather than just one end of the document 100.

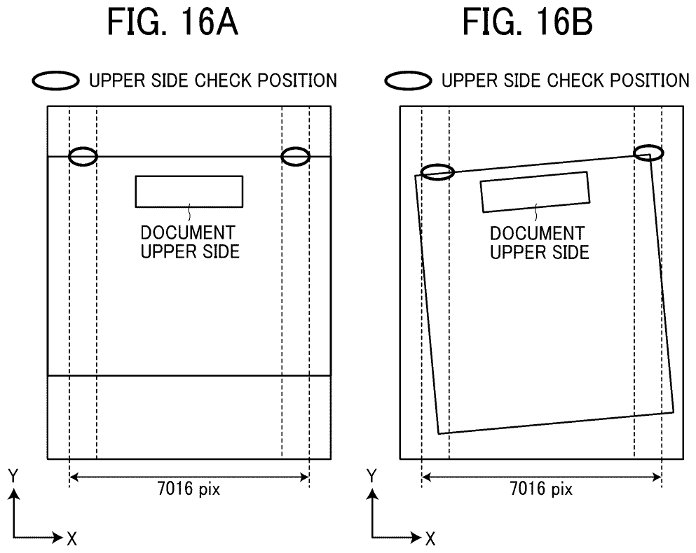

FIGS. 16A and 16B are diagrams each illustrating the execution of edge detection of the upper side of the document 100 in the image data. As illustrated in each of FIGS. 16A and 16B, the size determination unit 432 receives the detection result from the feature amount detection unit 431 and determines the size of the document 100 based on the detection result.

More specifically, when the detectable range of the imaging device 40 in the main scanning direction X is, for example, 7016 pixels, the size determination unit 432 determines whether the output level of the upper side of the document 100 near both ends in the main scanning direction X in the image data indicated by the ellipses in each of FIGS. 16A and 16B is equal to or lower than a threshold value (e.g., the level of the reference white plate 12).

When the size determination unit 432 determines that the output level of the upper side of the document 100 near both ends in the main scanning direction X in the image data indicated by the ellipses in FIG. 16A is equal to or lower than the threshold value (e.g., the level of the reference white plate 12), that is, when the upper edge of the document 100 in the main scanning direction X is detected at both ends by the feature amount detection unit 431, the size determination unit 432 determines that the main scanning width of the document 100 exceeds 7016 pixels and determines the main scanning width of the document 100 to be the width of a regular size (for example, A3 width).

In FIG. 16B, a case where the upper edge of the document 100 in the main scanning direction X is detected at both ends due to the inclination of the document is illustrated. At the end of the right side of the document illustrated in FIG. 16B, when a part of the upper edge is present in the detection area due to the inclination of the document or the like, the upper edge is assumed to be detected on the condition that, for example, the upper edge occupies a certain proportion of the detection area. In other words, when the upper edge of the document 100 in the main scanning direction X is detected at both ends by the feature amount detection unit 431, the size determination unit 432 determines that the main scanning width of the document 100 exceeds 7016 pixels and determines the main scanning width of the document 100 to be the width of a regular size (for example, A3 width).

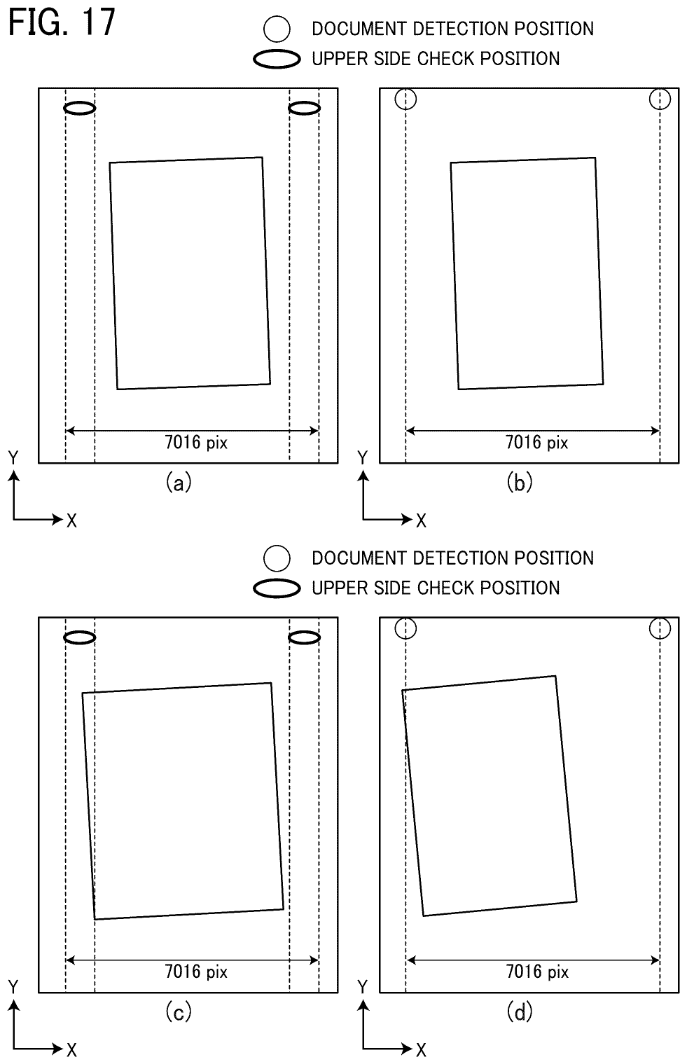

FIG. 17 is a diagram illustrating the case where the upper edge in the main scanning direction is not detected at both ends. Part (a) of FIG. 17 is a diagram illustrating the case where the upper edge of the document in the main scanning direction X in the edge detection is not detected at both ends. Part (b) of FIG. 17 is a diagram illustrating the case where the upper edge of the document in the main scanning direction X is not detected at both ends by the document width sensor. As illustrated in part (a) or (b) of FIG. 17, when the size of the document 100 does not exceed a preset size (detectable range) and the upper edge of the document 100 in the main scanning direction X is not detected at both ends, the upper edge of the document 100 in the main scanning direction X is detected except at both ends and the size of the document 100, which is the main scanning width, is determined based on the detection result. Part (c) of FIG. 17 is a diagram illustrating the case where the upper edge of the document 100 in the main scanning direction X is not detected at one of both ends in the edge detection. Part (d) of FIG. 17 is a diagram illustrating the case where the upper edge of the document 100 in the main scanning direction X is not detected at one of both ends by the document width sensor. When the upper edge of the document 100 in the main scanning direction X is not detected at one of both ends, the upper edge of the document 100 in the main scanning direction X is detected except at both ends, and the size of the document 100, which is the main scanning width, is determined based on the detection result.

In the present embodiment, the upper edge of the document 100 in the main scanning direction X is detected. For example, compared to a case where a document width sensor is disposed at only one side in the main scanning direction X, since the upper edge of the document 100 in the main scanning direction X can be detected at both ends, the erroneous detection of the size is prevented when the document 100 of an irregular size is read and the main scanning width is determined with high accuracy.

In the present embodiment, the main scanning width of the document 100 is determined based on the output level of the upper side of the document 100 near both ends in the main scanning direction X in the image data. However, the method of determining the main scanning with of the document 100 is not limited thereto. The main scanning width of the document 100 may be determined based on the output level of the lower side of the document 100 near both ends in the main scanning direction X in the image data.

A process of the size determination performed by the size determination unit 432 of the image reading device 101 is described below.

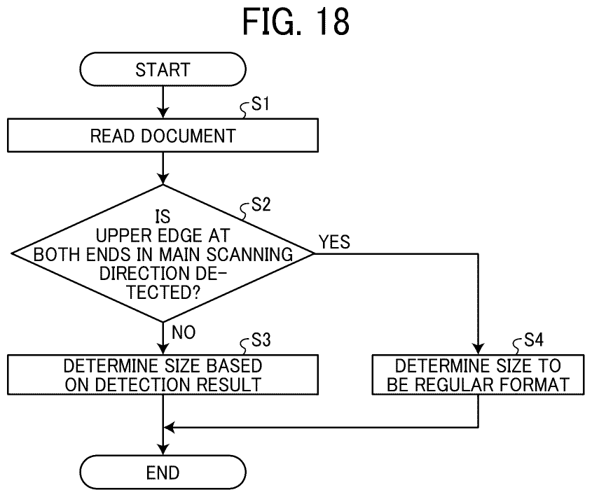

FIG. 18 is a flowchart of the process of the size determination. As illustrated in FIG. 18, the image reading device 101 controls the reading section 30 to read the document (step S1).

The image reading device 101 controls the feature amount detection unit 431 of the image processor 43 to detect the upper edge of the document 100 in the main scanning direction X at both ends in the image obtained by reading the document 100 (step S2).

When the image reading device 101 determines that the feature amount detection unit 431 does not detect the upper edge of the document 100 in the main scanning direction X at both ends (NO in step S2), the image reading device 101 determines that the document 100 is smaller than the detectable range and controls the size determination unit 432 to determine the main scanning width of the document 100 based on the detection result (step S3).

On the other hand, when the image reading device 101 determines that the feature amount detection unit 431 detects the upper edge of the document 100 in the main scanning direction X at both ends (YES in step S2), the image reading device 101 determines that the document 100 is larger than the detectable range and controls the size determination unit 432 to determine the main scanning width of the document 100 to be the width of a regular size (for example, A3 width) (step S4).

As described above, according to the present embodiment, when the upper edge of the subject in the main scanning direction X is detected at both ends by the feature amount detection unit (i.e., when the document 100 is larger than the detectable range), the size determination unit determines the main scanning width of the subject to be a predetermined width. Accordingly, even when the subject exceeds the detectable range, the main scanning width of the subject can be determined. Thus, for example, the image of the subject can be cut out to size.

### Second Embodiment

The second embodiment is described below.

The second embodiment differs from the first embodiment in that the edge detection is performed based on the detection performed by the document width sensor 52, whereas the edge detection is performed using the image in the first embodiment. In the detection by the document width sensor 52, the edge is considered to be detected by a signal that changes between on and off depending on the determination of whether the document is present. In the following description of the second embodiment, descriptions of elements identical or similar to those in the first embodiment are omitted, and differences from the first embodiment are described.

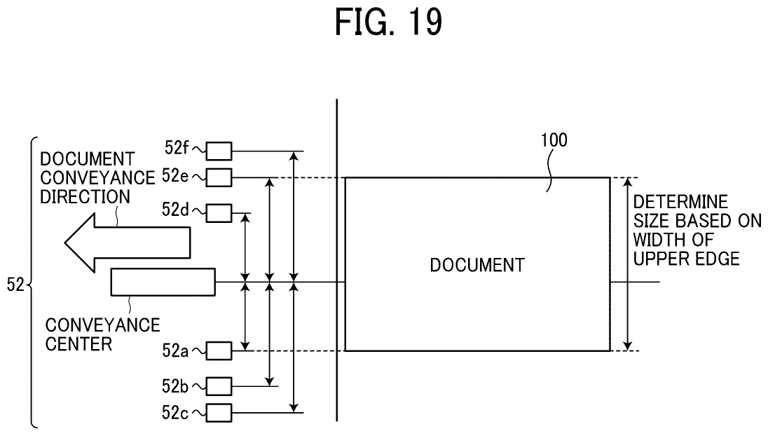

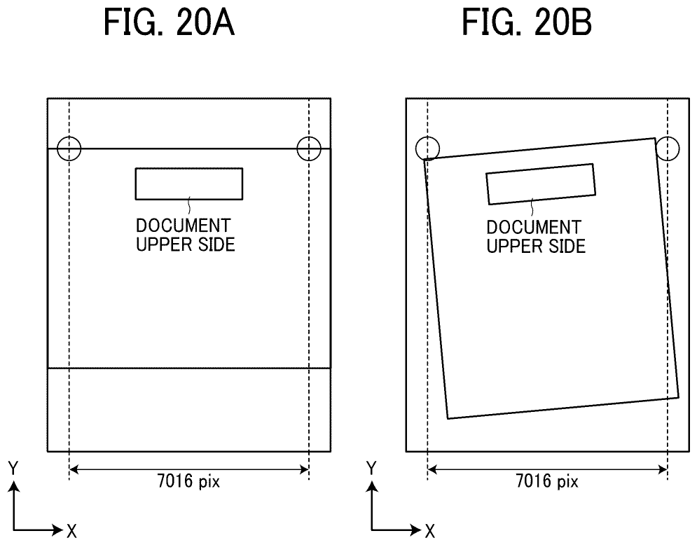

FIG. 19 is a diagram illustrating the disposition of the document width sensor 52 in the image reading device 101 according to the second embodiment. FIGS. 20A and 20B are diagrams each illustrating the edge detection in the image reading device 101.

As illustrated in FIG. 19, the document width sensor 52 of the image reading device 101 according to the present embodiment includes multiple light-receiving elements (52a, 52b, 52c, 52d, 52e, 52f), which are disposed on the left and right sides of the conveyance path 23 in accordance with the regular size of each document 100. For example, assuming that the detectable range of the imaging device 40 in the main scanning direction X is, for example, 7016 pixels, in the case of the reading using the ADF, the light-receiving elements of the document width sensor 52 are disposed in the vicinity of both ends of the left and right sides of the detectable range in the conveyance path of the document 100.

In the case of the reading in the flatbed method, the light-receiving elements of the document width sensor 52 may be disposed in the vicinity of both ends of the left and right sides of the detectable range in the reading region of the document 100 such that the row of the light-receiving elements in the main scanning direction are disposed in accordance with the regular size of each document 100.

The size determination unit 432 determines whether the width of the document in the conveyance path or in the reading area exceeds the detectable range using the document width sensor 52, and determines the size of the document.

When the size determination unit 432 determines, using the document width sensor 52, that the width of the document in the conveyance path or in the reading area does not exceed the detectable range, the size determination unit 432 determines the size, which is the main scanning width of the document 100, based on the width of the upper edge of the document 100 in the main scanning direction X in the image data.

As indicated by the circles in FIG. 20A, when the upper edge of the document 100 is detected by the light-receiving elements of the document width sensor 52 disposed at each of the left and right sides (when the document 100 is larger than the detectable range), the size determination unit 432 determines that the main scanning width of the document 100 exceeds 7016 pixels and determines the main scanning width of the document 100 to be the width of a regular size (for example, A3 width).

In addition, as indicated by the circles in FIG. 20B, when the upper edge of the document 100 is detected by the light-receiving elements of the document width sensor 52 disposed at each of the left and right sides due to the inclination of the document (when the document 100 is larger than the detectable range), the size determination unit 432 also determines the main scanning width of the document 100 to be the width of a regular size (for example, A3 width).

As described above, according to the present embodiment, when the upper edge of the subject in the main scanning direction X is detected at both ends by the document width sensor 52 (i.e., when the document 100 is larger than the detectable range), the size determination unit determines the main scanning width of the subject to be a predetermined width. Accordingly, even when the subject exceeds the detectable range, the main scanning width of the subject can be determined. Thus, for example, the image of the subject can be cut out to size.

### Third Embodiment

The third embodiment is described below.

The third embodiment differs from the first embodiment in that the edge detection using the image and the edge detection based on the detection by the document width sensor 52 are performed in combination, whereas only the edge detection using the image is performed in the first embodiment. In the following description of the third embodiment, descriptions of elements identical or similar to those in the first embodiment are omitted, and differences from the first embodiment are described.

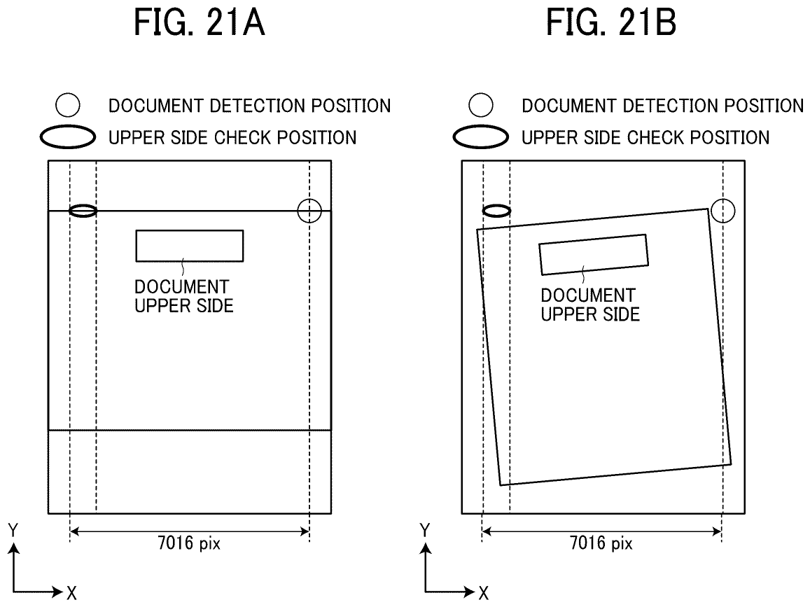

FIGS. 21A and 21B are diagrams each illustrating the edge detection in the image reading device 101 according to the third embodiment.

As illustrated in FIG. 4, the image reading device 101 includes the document width sensor 52 on one side. For example, assuming that the detectable range of the imaging device 40 in the main scanning direction X is, for example, 7016 pixels, in the case of the reading using the ADF, the light-receiving elements of the document width sensor 52 are disposed in the vicinity of one end of the left or right side of the detectable range (in the present embodiment, in the vicinity of the end of the right side of the detectable range) in the conveyance path of the document 100.

In the case of the reading in the flatbed method, the light-receiving elements of the document width sensor 52 may be disposed in the vicinity of one end of the left or right side of the detectable range (in the present embodiment, in the vicinity of the end of the right side of the detectable range) in the reading region of the document 100 such that the row of the light-receiving elements in the main scanning direction are disposed in accordance with the regular size of each document 100.

The size determination unit 432 receives the detection result from the document width sensor 52 and the detection result from the feature amount detection unit 431, and determines the size of the document 100.

When the size determination unit 432 determines that the output level of the upper side near the end of the left side of the document 100 in the image data is not equal to or lower than the threshold value (e.g., the level of the reference white plate 12) and the width of the document 100 is not detected in the vicinity of the end of the right side of the detectable range in the conveyance path or in the reading region by the document width sensor 52, the size determination unit 432 determines the size, which is the main scanning width of the document 100, based on the width of the upper edge of the document 100 in the main scanning direction X in the image data.

On the other hand, when the size determination unit 432 determines, using the document width sensor 52, that the width of the document 100 in the vicinity of the end of the right side of the detectable range in the conveyance path or in the reading region exceeds the detectable range as indicated by the circle in FIG. 21A and determines that the output level of the upper side near the end of the left side of the document 100, which is indicated by the ellipse in FIG. 21A, in the main scanning direction X in the image data is equal to or lower than the threshold value (e.g., the level of the reference white plate 12), that is, when the upper edge of the document 100 in the main scanning direction X is detected at both ends, the size determination unit 432 determines that the main scanning width of the document 100 exceeds 7016 pixels and determines the main scanning width of the document 100 to be the width of a regular size (for example, A3 width).

When the size determination unit 432 determines, using the document width sensor 52, that the width of the document 100 in the vicinity of the end of the right side of the detectable range in the conveyance path or in the reading region exceeds the detectable range due to the inclination of the document as indicated by the circle in FIG. 21B and determines that the output level of the upper side near the end of the left side of the document 100, which is indicated by the ellipse in FIG. 21B, in the main scanning direction X in the image data is equal to or lower than the threshold value (e.g., the level of the reference white plate 12), that is, when the upper edge of the document 100 in the main scanning direction X is detected at both ends, the size determination unit 432 determines that the main scanning width of the document 100 exceeds 7016 pixels and determines the main scanning width of the document 100 to be the width of a regular size (for example, A3 width).

As described above, the image reading device 101 of the present embodiment detects whether the document is present with the light-receiving elements of the document width sensor 52 disposed on only one of the left and right sides, and detects the upper edge at one end on the other side of the one of the left and right sides in the read image data.

According to the technique in the related art, when an image reading sensor or an optical system having a limited detection range in the main scanning area is used for reading a document to generate image data, there is an issue that the edge portion of the document having the width of the edge exceeding the width of the main scanning area cannot be detected. On the other hand, when a sensor or an optical system having a wide detection range is used for the purpose of expanding the detection range in the main scanning area, there is another issue that the housing is required to be large and the cost is high.

As described above, according to the present embodiment, when the upper edge of the subject in the main scanning direction X is detected at both ends by the feature amount detection unit 431 and the document width sensor 52 (i.e., when the document 100 is larger than the detectable range), the size determination unit determines the main scanning width of the subject to be a predetermined width. Accordingly, even when the subject exceeds the detectable range, the main scanning width of the subject can be determined. Thus, for example, the image of the subject can be cut out to size.

In addition, according to the present embodiment, the cost can be reduced as compared with the case where the light-receiving elements of the document width sensor 52 are disposed at both ends in the main scanning direction X. Thus, both cost and functionality are achieved at the same time.

The program executed by the image forming apparatus 1 according to the embodiments described above may be configured to be recorded in any computer-readable recording medium, such as a compact disc read-only memory (CD-ROM), a flexible disk (FD), a compact disc-recordable (CD-R), or a digital versatile disc (DVD), in an installable or executable file format and provided as a computer program product.

Alternatively, the program to be executed by the image forming apparatus 1 according to the embodiments described above may be configured to be stored in a computer connected to a network such as the Internet and provided by being downloaded via the network. Further, the program to be executed by the image forming apparatus 1 according to the embodiments described above may be configured to be provided or distributed via a network such as the Internet. Furthermore, the program to be executed by the image forming apparatus 1 according to the embodiments described above may be incorporated in, for example, a read-only memory (ROM) in advance and provided.

The program executed by the image forming apparatus 1 according to the embodiments described above has a module structure including at least one of the above-described functional units (such as the feature amount detection unit 431 and the size determination unit 432). As actual hardware, a processor such as the CPU reads the program from the above-described recording medium and executes the program to load the above-described functional units onto a main storage device and implements the feature amount detection unit 431 and the size determination unit 432.

In the embodiments described above, the image forming apparatus according the present disclosure is applied to a multifunction peripheral (MFP) that has at least two of a copying function, a printing function, a scanning function, and a facsimile communication function. However, no limitation is indicated thereby, and the image forming apparatus according to the present disclosure may be applied to any image forming apparatus such as a copier, a printer, a scanner, and a facsimile machine.

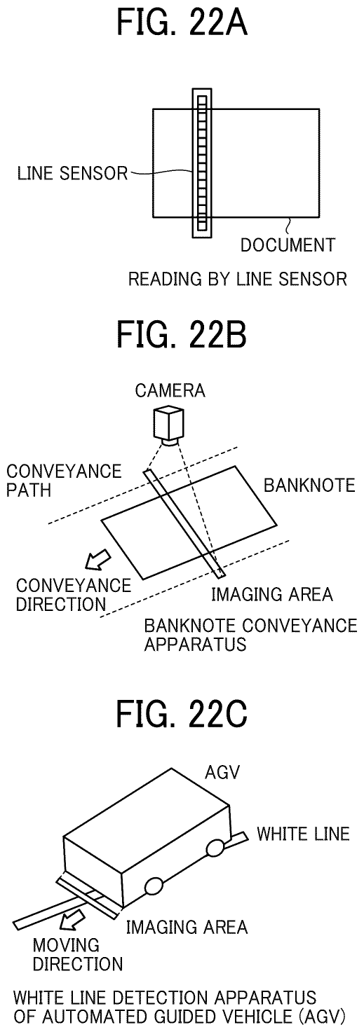

In the embodiments described above, the image reading device 101 of the image forming apparatus 1 serves as a reading device. The reading device may be any apparatus that can read a subject at a readable level such as a line sensor employing an equal magnification optical system (contact optical system: contact image sensor (CIS) system) illustrated in FIG. 22A, instead of reading the subject as an image. FIGS. 22A to 22C are diagrams each illustrating the reading device according to a modification. The apparatus illustrated in FIG. 22A reads information of multiple lines by moving a line sensor or a document.

Furthermore, the reading device can also be applied to a banknote conveyance apparatus illustrated in FIG. 22B and a white line detection apparatus of an automated guided vehicle (AGV) illustrated in FIG. 22C.

The subject of the banknote conveyance apparatus illustrated in FIG. 22B is a banknote. The feature amount detected by the banknote conveyance apparatus is used for, for example, the correction of the image itself. In other words, the banknote conveyance apparatus illustrated in FIG. 22B recognizes the inclination of the banknote by edge detection and performs skew correction based on the recognized inclination.

The subject of the white line detection apparatus of the AGV illustrated in FIG. 22C is a white line. The feature amount output by the white line detection apparatus of the AGV can be used for, example, the determination of a moving direction of the AGV. In other words, the white line detection apparatus of the AGV recognizes the inclination of a white-line area by edge detection and determines the moving direction of the AGV based on the recognized inclination. In addition, the white line detection apparatus of the AGV can correct the moving direction according to the position and orientation of the AGV in a later process. For example, the AGV including the white line detection apparatus can execute processing such as stopping driving when detecting a thickness different from the known thickness of the white line.

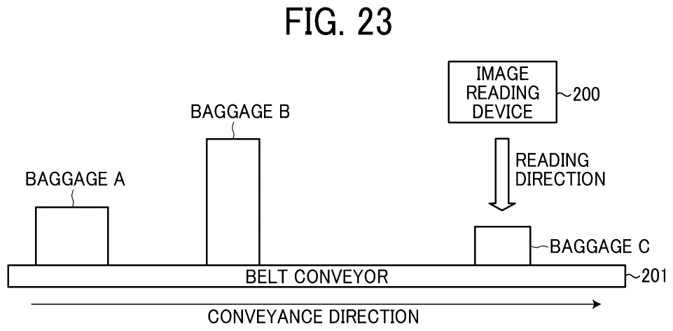

FIG. 23 is a diagram illustrating the reading device according to another modification. In FIG. 23, a case is illustrated, in which the reading device is applied to an image reading device 200 used when a baggage is packaged at, for example, a production site.

The subjects of the image reading device 200 illustrated in FIG. 23 are pieces of baggage A, B, and C of different sizes, which are objects to be transported. As illustrated in FIG. 23, when the pieces of baggage A, B, and C of different sizes are conveyed by a belt conveyor 201, the image reading device 200 of the present disclosure detects the feature amount (edge) of each of the pieces of baggage A, B, and C to detect the width of each piece of baggage. In detecting the feature amounts of the pieces of baggage A, B, and C, visible light is effective for black baggage, and invisible light is effective for white baggage.

In this case, the background portion 26 may be a surface of the belt conveyor 201, or the background portion 26 may be disposed as a dedicated background portion by setting the reading position of the image reading device 200 to a gap in the belt conveyor 201.

The image reading device 200 detects the feature amount (edge) of each piece of baggage A, B, and C being conveyed, and detects the width of each piece of baggage based on the detection result of the feature amount of each of the piece of baggage A, B, and C. Accordingly, the size of the container used for packaging the baggage is selectable, and waste such as the use of an excessively large container is prevented.

Aspects of the present disclosure are, for example, as follows.

According to Aspect 1, a reading device includes a light source, an imaging device, an edge detection unit, and a size determination unit. The light source irradiates a subject with light. The imaging device receives light reflected from the subject to generate an image. The edge detection unit detects an edge of the subject. The size determination unit determines the size of the subject in accordance with a detection result from the edge detection unit. In the case where the upper edge or the lower edge of the subject in the main scanning direction of the imaging device is not detected at both ends by the edge detection unit, the size determination unit determines the width of the subject in the main scanning direction. In the case where the upper edge or the lower edge of the subject in the main scanning direction of the imaging device is detected at both ends by the edge detection unit, the size determination unit determines the width of the subject in the main scanning direction to be a predetermined width.

According to Aspect 2, in the reading device of Aspect 1, the edge detection unit detects the upper edge or the lower edge of the subject in the main scanning direction at both ends using the image generated by the imaging device, and the size determination unit determines the width of the subject in the main scanning direction in the image generated by the imaging device depending on the determination of whether the upper edge or the lower edge of the subject in the main scanning direction is detected at both ends.

According to Aspect 3, in the reading device of Aspect 1, the edge detection unit is a detection sensor disposed at a predetermined interval between both ends in the main scanning direction in the detectable range of the imaging device in the conveyance path of the subject or the reading region of the subject, and the size determination unit determines the width of the subject in the main scanning direction depending on the determination of whether the subject is detected by the detection sensor.

According to Aspect 4, in the reading device of Aspect 1, the edge detection unit detects the upper edge or the lower edge of the subject in the main scanning direction at one end of both ends using the image generated by the imaging device, and is a detection sensor disposed at the other end of both ends in the main scanning direction in the detectable range of the imaging device in the conveyance path of the subject or the reading region of the subject, and the size determination unit determines the width of the subject in the main scanning direction depending on the determination of whether the upper edge or the lower edge of the subject in the main scanning direction is detected at the one end of both ends in the image generated by the imaging device and whether the subject is detected at the other end of both ends in the main scanning direction by the detection sensor.

According to Aspect 5, in the reading device of any one of Aspects 1 to 4, in the case where the upper edge or the lower edge of the subject in the main scanning direction is not detected at both ends or at at least one of both ends by the edge detection unit, the size determination unit determines the width of the subject in the main scanning direction.

According to Aspect 6, in the reading device of any one of Aspects 1 to 5, the light source irradiates the subject with visible light and invisible light, the imaging device receives the visible light and the invisible light reflected from the subject and captures a visible image and an invisible image, and the edge detection unit detects the upper edge or the lower edge of the subject in at least one of the visible image and the invisible image.

According to Aspect 7, in the reading device of any one of Aspects 1 to 6, the subject is an object to be transported.

According to Aspect 8, an image processing apparatus includes the reading device according to any one of Aspects 1 to 7 and an image forming device.

According to Aspect 9, a reading method performed by a reading device includes irradiating, receiving, detecting, and determining. The reading device includes a light source, an imaging device, an edge detection unit, and a size determination unit. The irradiating is irradiating, with the light source, a subject with light. The receiving is receiving, with the imaging device, light reflected from the subject to generate an image. The detecting is detecting, with the edge detection unit, an edge of the subject. The determining is determining, with the size determination unit, the size of the subject in accordance with the detection result from the edge detection unit. In the case where the upper edge or the lower edge of the subject in the main scanning direction of the imaging device is not detected at both ends by the edge detection unit, the determining is determining, with the size determination unit, the width of the subject in the main scanning direction. In the case where the upper edge or the lower edge of the subject in the main scanning direction of the imaging device is detected at both ends by the edge detection unit, the determining is determining, with the size determination unit, the width of the subject in the main scanning direction to be a predetermined width.

According to Aspect 10, a non-transitory recording medium stores a plurality of program codes which, when executed by a computer, causes a reading device to perform a method including irradiating, receiving, detecting, and determining. The reading device includes a light source, an imaging device, an edge detection unit, and a size determination unit. The irradiating is irradiating, with the light source, a subject with light. The receiving is receiving, with the imaging device, light reflected from the subject to generate an image. The detecting is detecting, with the edge detection unit, an edge of the subject. The determining is determining, with the size determination unit, the size of the subject in accordance with the detection result from the edge detection unit. In the case where the upper edge or the lower edge of the subject in the main scanning direction of the imaging device is not detected at both ends by the edge detection unit, the determining is determining, with the size determination unit, the width of the subject in the main scanning direction. In the case where the upper edge or the lower edge of the subject in the main scanning direction of the imaging device is detected at both ends by the edge detection unit, the determining is determining, with the size determination unit, the width of the subject in the main scanning direction to be a predetermined width.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A reading device comprising:
a light source to irradiate a subject with light;
an imaging device to receive light reflected from the subject to generate an image; and
circuitry configured to:
detect an edge of the subject to obtain a detection result;
determine a size of the subject in accordance with the detection result;
in a case that the detection result indicates that an upper edge or a lower edge of the subject in a main scanning direction of the imaging device is not detected at both ends, determine a width of the subject in the main scanning direction; and
in a case that the detection result indicates that the upper edge or the lower edge of the subject in the main scanning direction is detected at both ends, determine the width of the subject in the main scanning direction to be a preset width.

2. The reading device according to claim 1, wherein the circuitry is configured to:
detect the upper edge or the lower edge of the subject in the main scanning direction using the image; and
determine the width of the subject in the main scanning direction in the image.

3. The reading device according to claim 1, further comprising:
a detection sensor in a conveyance path of the subject or a reading region of the subject, the detection sensor being disposed at a preset interval between both ends of a detectable range of the imaging device in the main scanning direction, wherein
the circuitry is configured to determine the width of the subject in the main scanning direction based on a determination indicating whether the subject is detected by the detection sensor.

4. The reading device according to claim 1, further comprising:
a detection sensor in a conveyance path of the subject or a reading region of the subject,
wherein the circuitry is configured to:
detect the upper edge or the lower edge of the subject in the main scanning direction at one end of both ends using the image;
detect the upper edge or the lower edge of the subject in the main scanning direction at another end of both ends using the detection sensor being disposed at the other end of both ends of a detectable range of the imaging device in the main scanning direction; and
determine the width of the subject in the main scanning direction based on a determination indicating whether the upper edge or the lower edge of the subject is detected at the one end in the image and whether the upper edge or the lower edge of the subject is detected at the other end by the detection sensor.

5. The reading device according to claim 1, wherein the circuitry is configured to, in a case that the detection result indicates that the upper edge or the lower edge of the subject in the main scanning direction is not detected at least one end, determine the width of the subject in the main scanning direction.

6. The reading device according to claim 1, wherein:
the light source irradiates the subject with visible light and invisible light;
the imaging device receives the visible light and the invisible light reflected from the subject and captures a visible image and an invisible image; and
the circuitry is configured to detect the upper edge or the lower edge of the subject in at least one of the visible image or the invisible image.

7. The reading device according to claim 1, wherein the subject is an object to be transported.

8. An image processing apparatus comprising:
the reading device according to claim 1; and
an image forming device to form an image based on the image read by the reading device.

9. A reading method performed by a reading device, the method comprising:
irradiating, with a light source, a subject with light;
receiving, with an imaging device, light reflected from the subject to generate an image;
detecting an edge of the subject to obtain a detection result;
determining a size of the subject in accordance with the detection result;
in a case that the detection result indicates that an upper edge or a lower edge of the subject in a main scanning direction of the imaging device is not detected at both ends, the method further comprising determining a width of the subject in the main scanning direction; and
in a case that the detection result indicates that the upper edge or the lower edge of the subject in the main scanning direction is detected at both ends, the method further comprising determining the width of the subject in the main scanning direction to be a preset width.

10. A non-transitory recording medium storing a plurality of program codes which, when executed by one or more processors, causes the one or more processors to perform a method, the method comprising:
irradiating, with a light source, a subject with light;
receiving, with an imaging device, light reflected from the subject to generate an image;
detecting an edge of the subject to obtain a detection result;
determining a size of the subject in accordance with the detection result;
in a case that the detection result indicates that an upper edge or a lower edge of the subject in a main scanning direction of the imaging device is not detected at both ends, the method further comprising determining a width of the subject in the main scanning direction; and
in a case that the detection result indicates that the upper edge or the lower edge of the subject in the main scanning direction is detected at both ends, the method further comprising determining the width of the subject in the main scanning direction to be a preset width.
